(19) United States
(12) Patent Application Publication
(10) Pub. No.: US 2020/0041243 A1
(43) Pub. Date: Feb. 6, 2020

(54) Anti-Explosion Protection System For Damping Barriers

(71) Applicant: Fhecor Ingenieros Consultores, S.A., Madrid (ES)

(72) Inventor: Alejandro Rafael Perez Caldentey, Madrid (ES)

(73) Assignee: Fhecor Ingenieros Consultores, S.A., Madrid (ES)

(21) Appl. No.: 16/499,091

(22) PCT Filed: Mar. 28, 2018
(86) PCT No.: PCT/ES2018/070267

§ 371 Date: Sep. 27, 2019

(30) Foreign Application Priority Data
Mar. 31, 2017 (ES) P201730533

(51) Int. Cl. F42D 5/04; F16F 7/116

(52) U.S. Cl. CPC F42D 5/04; F16F 7/116

(57) ABSTRACT

The present invention relates to an anti-explosion protection system based on containment barriers, which allows energy to be absorbed using a damping system formed by two walls that are connected by means of oscillators. According to the invention, the front wall (1) is supported by a system of bearings or a sliding surface (4) allowing the front wall to move relative to the second wall (2). The front wall receives the pressure wave and, owing to the movement of the mass of said front wall (1), a reduced pressure is transmitted to the rear wall (2), which is protected by the system. In said barrier, a large part of the energy from the explosion is transformed into the kinetic energy of an oscillating mass.

The present invention reveals a system of blast loading protection by means of containment barriers, which allows energy to be absorbed by means of a damping system made up of two walls connected by oscillators, where a first wall receives the pressure wave and transmits a reduced pressure to the second wall thanks to the movement of the mass of the first wall.

### BACKGROUND OF THE INVENTION

Safety barriers are a possible alternative to the provision of an adequate safety distance and are a clear solution when there is not enough space available (a situation that occurs systematically within large transportation centers). Moreover, if the barriers are properly implemented, they can ensure a high level of safety.

Barriers are mainly used to attenuate the pressure wave and stop the high-velocity fragments that form as a consequence of the explosion and that can come into contact with elements of the receiving system (set of elements that require protection, such as people, equipment or secondary explosives).

However, due to their configuration, protective barriers are only useful if they are located at a short distance from the explosion (generally not more than ten times the height of the barrier), whereas for longer distances, these elements do not give rise to adequate attenuation.

Barriers can have several forms: they can be covered or not, they can be cantilever walls or structures in form of cubes in which one or more sides (and/or the roof) can be open or closed to prevent the entrance to the protected elements.

They can also be subdivided into continuous and porous barriers.

To mitigate the danger of coal dust explosions, coal deposits were kept damp. This procedure was substituted after the First World War by the mineral powder procedure that was prescribed at first for coal veins with high volatility coals and then for all veins. These mineral powder barriers are intended to resist and limit the effects of explosions, which is also the object of the so-called water barriers that were introduced after the Second World War. In both mineral powder barriers and water trough barriers, a support frame is attached to the mine gallery shoring, on which the actual mineral powder barriers or individual water troughs are then placed. The explosion wave that strikes the barrier installation destroys the barrier, so that the applied mineral powder or water is distributed across the gallery and extinguishes the flame that follows the pressure wave.

The state-of-the-art rigid retaining devices consist of so-called splice consoles (housing elements) which are mounted on part of the shoring with hook screws. On the splice consoles, crossbeams are fixed in the longitudinal direction to the gallery axis. In the blocking systems of the crossbeams, beams are inserted that run transversally to the axis of the gallery and that are kept together by means of blocking systems. The beams mounted in this way are then used to install or suspend water troughs. Explosion barriers of this type of construction are costly as a result of the large number of them that have to be installed in an underground mine. The aim is, therefore, to use as an explosion barrier, a construction type that is as cheap as possible.

Other protective structures are bomb shelters that consist of steel-reinforced concrete structures, usually mounted at ground level or below the ground, with special reinforced concrete walls large thickness. However, the disadvantage of conventional bomb shelters is that, because they are located at or below ground level, they are particularly susceptible to chemical attack, as the chemicals normally used have a higher density than air and, therefore, accumulate in low locations near ground level. This problem was faced by the Israeli authorities during the Gulf War from 1990 to 1991, when it was necessary to warn the civilian population about how they could best shelter themselves in the event of a missile attack as the missiles were suspected of carrying chemical warheads.

It would, therefore, be desirable to construct the upper parts of buildings, e.g. apartments and offices, in such a way that they would be explosion-resistant. However, this is not practical, as reinforced concrete walls built to the thickness normally required would be excessively expensive.

Also known, are composite structures that include the grouping of hollow blocks with a plurality of intercommunicated holes filled with a mass of reinforced concrete. These constructions using slag blocks or concrete are the object of U.S. Pat. No. 1,884,319 by Smith and U.S. Pat. No. 2,994.162 by Frantz. Smith describes the use of his structure to provide insulation against “heat, cold and humidity”. Frantz states that his construction is simply easier to assemble than other block wall constructions. U.S. Pat. No. 4,577,447 by Doran reveals a construction similar to those of the above patents but uses expanded polystyrene blocks.

The Spanish patent application P9402107 reveals a hollow block formed by a mixture of mineralized wood shavings and concrete with a density not exceeding, approximately, 1 t per cubic meter, for the construction of a wall of blocks and reinforced concrete to absorb the energy of an explosion. Within the hollow block, there are openings in orthogonal directions that allow the reinforced concrete to be placed through them, and because the hollow block is load-bearing, it cooperates with the reinforced concrete to resist explosion forces. Also revealed is a procedure for building an explosion-resistant wall that includes the following steps: the grouping of a plurality of the hollow blocks described above to form a wall. The blocks have in their interior vertical and horizontal holes, and it is possible to place the blocks one on top of another and one alongside another so that the vertical and horizontal holes of the adjacent blocks are aligned. An integral grid of concrete and reinforcing steel is formed in the interconnected vertical and horizontal holes, obtaining a composite wall construction with the hollow blocks and reinforced concrete, from the grouping a plurality of hollow blocks and forming an integral grid giving the composite wall construction the ability to substantially retain its structural integrity in the presence of explosion forces of sufficient magnitude to destroy a wall of blocks and reinforced concrete that does not use such hollow blocks.

Document EP 0009654 A1 describes an explosion-proof barrier in which two parallel walls are involved, a chamber is defined between them, with a series of angular folds that act as shock-absorbing elements on the front wall, so that this can be displaced by the deformation of these elements, absorbing the energy received from the impact by plastic deformation. These types of structure are of single-use, since once the internal structure has been deformed, the barrier does not return to its initial position, becoming useless or materially weakened against another impact.

A similar situation occurs in the case of the invention patent WO 9830772, relating to a construction panel in which two external and extreme walls are defined between which an internal nucleus is established based on a honeycomb of cells, the structure of which is susceptible to deformation in the event of an explosion to absorb its energy. As in the patent previously described, these types of structure are single-use in nature, since once the internal structure has been deformed, the panel becomes unusable or materially weakened for resisting another impact.

Document WO 2009085966 A1 also describes a structure designed to absorb the energy produced in explosions and similar, in which this structure is designed to work through flexure of vertical elements within the structure of the wall, not providing means of cushioning against impacts perpendicular to the wall, so its application is significantly different from the objective of this invention.

U.S. Pat. No. 6,298,607 describes a ventilated membrane to mitigate the effects of explosions, involving a highly complex structure, in which multiple inflatable and deformable chambers are defined, designed to cushion the effects of a possible explosion, so that, as has just been said, it is a structure involving a large number of flexible elements, intercommunicating chambers that must be watertight for proper operation, which ultimately makes the installation complex and consequently expensive.

On the other hand, patent U.S. Pat. No. 3,500,773 describes a system of protection against the impact of projectiles involving a frontal and metallic wall destined to receive the impact in question. This is divided into sectors that are joined to a posterior wall that forms part of the structure to be protected, and where the union between both walls is made by means of elastic elements, such as springs, with the particularity that means are established between both elements that limit the magnitude or distance that this metallic wall is displaced with respect to the posterior wall.

These elements that limit the distance or margin of displacement of the metal wall are embodied in metal profiles that occupy a considerable volume within the chamber that is defined between the anterior metal wall and the posterior wall, such that the aforementioned barrier that constitutes this structure is designed to behave in two well-differentiated operational phases.

In an initial phase, the protection system has a merely elastic character, in which the metal plates participating in it move along complementary profiles against the elastic media until they come into contact with the profiles that function as stops associated with the concrete back wall.

Thus, in this first phase, there is a small displacement of the metal plate that is subjected to a small impact, being able to return to its initial position by the elastic effect of the recovery media contained inside it.

However, when it comes to more powerful impacts, the system behaves in a plastic way, that is to say, that the elements functioning as stops, arranged in the space defined between both walls, are deformed and flattened to allow the metal plates to move a greater distance, in such a way that, as in the other patents mentioned above, the structure is irreversibly damaged after the explosion.

Consequently, this system presents a problem in which the following aspects should be highlighted:
Since it requires elements to function as stops between both walls, as well as to define a space or range of displacement with respect to this stop, the wall must have a large volume.
Its plastic behaviour in the event of powerful explosions makes it single-use.
The front wall, based on metal plates, is made of multiple independent plates, which complicates assembly.

Finally, patent U.S. Pat. No. 4,718,356 can be mentioned, in which a system was revealed to protect a wall against damage caused by explosions, in which the wall itself can be displaced by the expansion wave of the explosion through guides perpendicular to it with a means of braking that opposes this displacement.

Although this solution is effective against expansive waves, it does not plan for the impact of shrapnel or other objects that could damage the wall.

At the same time, once the impact has been absorbed, the wall will be blocked and displaced with respect to its initial position, which would require a complex and consequently costly “re-assembly” process, if this were possible, since otherwise the wall would not withstand a new impact should it occur.

The present invention reveals a barrier system against explosions based on elastic damping, in which much of the energy of the explosion is transformed into the kinetic energy of an oscillating mass, so that the system is not single-use, as described above, and can withstand multiple impacts without affecting its internal structure.

The proposed system proves to be very effective and is formed from elements that are easy to manufacture and install. It is of a type that enables adequate integration into architecture and can be combined with windows that allow visualization of the damping system. A clear application of this can be the protection of control rooms.

### DESCRIPTION OF THE FIGURES

To complement the description here and in order to give a better understanding of the characteristics of the invention, in accordance with a preferred example of its practical embodiment, it is accompanied by a set of FIGURES that form an integral part of the description and represent for the purposes of illustration and without limitation the following:

FIG. 1.—shows a view of the system representing the arrangement of the walls and oscillators with respect to the sliding surface.

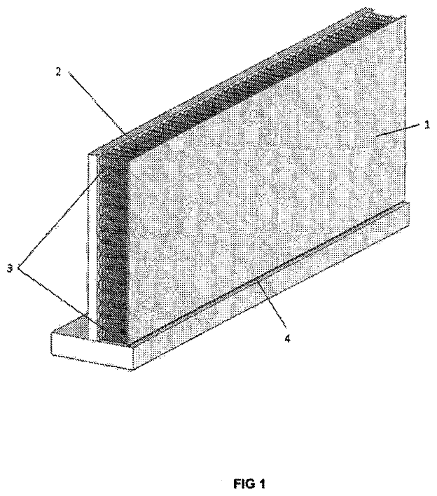

### DESCRIPTION OF THE INVENTION

The system has two walls joined together by a plurality of oscillators of a degree of freedom(mᵢ, kᵢ, cᵢ). The front wall that would concentrate a certain mass (the greater the mass, the better), for which it is conceived as a metallic element, would receive the pressure wave and transmit it to the reaction wall, which would be made of concrete, with a reduced pressure thanks to the setting in motion of the mass of the front wall

The front wall, which receives the shock wave, is supported by a system of wheels or bearings or rails, or supported on a sliding surface so that it can move independently of the rear wall.

Therefore, the system is based on dissipating part of the energy generated by the explosion through setting in motion an initially static mass (the front wall). The rear wall can be part of the barrier system or directly part of the structure to be protected.

The front wall can be made of steel which provides both high mass and adequate strength. The mass can be increased by adding metal boxes to the front wall to add soil, for example.

The system can be integrated into the architecture in multiple ways that can include all types of metal surface treatments. Likewise, the system can be enhanced from an architectural point of view, leaving the oscillators visible, either from a side or through “windows” in the metal panel. A system of this type can be effective for protecting a control room, for example, at a reasonable cost.

### PREFERRED EMBODIMENT OF THE INVENTION

The system of the present invention comprises a barrier formed by a frontal wall (1) preferably metallic, which receives the pressure wave at the time of the explosion, where the said frontal wall (1) can be considered as a metallic element of a certain mass. The front wall (1), made of metal, is supported by a sliding surface (4) that enables its displacement and where this front wall (1) is in contact with a rear wall (2) preferably of concrete by means of a plurality of oscillators (3), of a single degree of freedom, which can be springs or similar. The barrier system works in such a way that at the time of the explosion, the front wall (1) receives a pressure wave that is transmitted to the rear wall (2) by means of the plurality of oscillators (3) interspersed between both walls due to the movement of the front wall (1), resulting in a reduced pressure on the rear wall (2), since only a part of the energy of the explosion is transformed into energy of deformation of the springs, the rest of the energy being dissipated in providing movement to the front wall.

The sliding surface (4) can be replaced by a system of roller bearings or a system of sliding rails.

To analyze the response of the oscillator system, the explosion can be treated as an impulse on the outer wall, i.e. the frontal wall (1) of metal. If the duration of the law of triangular pressures is short with respect to the period of the oscillators (3), as is the case, the impulse is equivalent to imposing an initial velocity on the plurality of oscillators (3) of a value equal to the value of the impulse divided by the mass. Under these conditions, assuming, in a simplified way and as an initial approximation, that the shock absorbers move synchronously, the equation of motion of the wall as a whole can be written as indicated in the following equation

$$\begin{matrix}x ( t ) = {e}^{- {ξω}_{n} t} \frac{{\dot{x}}_{0}}{{ω}_{d}} sin {ω}_{d} t = {e}^{- {ξω}_{n} t} \frac{{iA}_{wall}}{{ω}_{d} \sum {m}_{i}} sin {ω}_{d} t = {e}^{- {ξω}_{n} t} \frac{\frac{1}{2} {p}_{r} {t}_{rf} {A}_{wall}}{{ω}_{d} \sum {m}_{i}} sin {ω}_{d} t & \\ {ω}_{n} = \sqrt{\frac{K}{M}} & \\ {ω}_{d} = {ω}_{n} \sqrt{1 - {ξ}^{2}} & \end{matrix}$$

ξ is the damping index
i is the impulse to the wall due to the explosion
pᵣ is the reflected pressure due to the explosion that is imposed on the barrier
t_{rf} is the duration of the equivalent triangular wave
A_{wall} is the area of the wall affected by the pressure of the explosion
ωₙ is the natural frequency of the system of 1 gdl
ω_{d} is the natural damped frequency of the system of 1 gdl
mᵢ mass of each of the harmonic oscillators M=Σmᵢ

The system can be appreciated in a simpler way by means of a numerical example

### Example 1

Assuming a detonation, an explosive equivalent to 20 kg TNT located 3.00 meters from the wall, the reflected pressure, pᵣ, would be 3952 kPa, and the duration of the equivalent triangular law of pressures, t_{rf} would be 0.68 ms. Admitting that there are 4 steel springs per square metre of wall, that the springs have an average diameter of 25 cm(D), 20 mm bar diameter, d, and 9 coils(/V), the stiffness of the 4 springs would be:

$$K = {n}_{springs} \frac{{Gd}^{4}}{8 {D}^{3} N} = 4 \frac{200 \times {10}^{6}}{2 ( 1 + 0.3 )} \frac{{0.02}^{4}}{8 \times {0.25}^{3} \times 9} = 43.8 kN \text{/} {m}^{3}$$

Regarding the mass of the system, it would be necessary to have the mass of the panel (MP) plus the mass of the 4 springs, so that per square meter, if it is assumed that the front panel is a steel plate of 40 mm thickness, the mass would be:

$$M = {M}_{p} + 4 \times {M}_{spring} = 7.85 \times ( 0.04 \times 1 \times 1 + 4 \times 9 \times π \times 0.25 \times \frac{π \times {0.02}^{2}}{4} ) == 7.85 \times ( 0.04 + 0.0088 ) = 0.384 t \text{/} {m}^{2}$$

Therefore, the angular frequency of the system and the damped angular frequency (assuming damping, consistent with a metallic structure of 1%) would be:

$${ω}_{n} = \sqrt{\frac{K}{M}} \sqrt{\frac{43.8}{0.384}} = 10.67 rad \text{/} s \to T = \frac{2 π}{{ω}_{n}} = \frac{2 π}{10.67} = 0.59 s$$

$${ω}_{d} = {ω}_{n} \sqrt{1 - {ξ}^{2}} = 10.67 \sqrt{1 - {0.01}^{2}} = 10.67 rad \text{/} s$$

By applying the expression of x(t), the displacement due to the explosion and the corresponding reaction in the concrete wall can be determined.

$$x ( t = T \text{/} 4 ) = {e}^{- {ξω}_{n} \frac{T}{4}} \frac{\frac{1}{2} {p}_{r} {t}_{rf} {A}_{wall}}{{ω}_{d} \sum {m}_{i}} sin {ω}_{d} \frac{T}{4} = {e}^{- 0.01 \times 10.67 \times \frac{0.59}{4}} \frac{\frac{1}{2} 3952 \times 0.68 \times {10}^{- 3} \times 1}{10.67 \times 0.384} \times 1.0 = 0.984 \times 0.328 = 0.32 m$$

$${q}_{wall} = 43.8 \times 0.32 = 14.02 kPa$$

It is observed that a high load is obtained, but is compatible with the size of a conventional wall. For a wall height of 3.00 m, and assuming that the wall is simply supported and that the depth of the wall is 25 cm (a minimum value), the required reinforcement would correspond to a minimum amount, as can be seen in the following equation and it would not be necessary to have shear reinforcement:

$${M}_{Ed} = 14.02 \times \frac{{3}^{2}}{8} = 15.77 kNm \text{/} m \to {A}_{s} = \frac{{M}_{Ed}}{z {f}_{yd}} \approx \frac{15.77}{0.9 \times 0.2} \frac{1.0}{50} = 1.75 {cm}^{2} \text{/} m$$

$${V}_{Ed} = 14.02 \times \frac{3}{2} = \frac{21.03 kN}{m} \to τ = \frac{{V}_{Ed}}{bd} = \frac{21.03}{0.2} = 0.1 MPa \to Does not require shear reinforcement$$

In order to evaluate what would be the difference compared to the unprotected wall, in the same case, one would have:

$${K}_{E} = \frac{{P}_{E}}{{δ}_{max}} = \frac{{P}_{E}}{\frac{5 {pL}^{4}}{384 EI}} = \frac{{K}_{L}}{\frac{5 {L}^{3}}{384 EI}} = \frac{384}{5} \frac{0.64 \times 3 \times {10}^{7} \frac{1}{12} {0.25}^{3}}{{3}^{3}} = \\ 71111 kN \text{/} {m}^{2}$$

$${M}_{E} = {K}_{M} M = 0.50 \times {0.25 \times 2.5}_{{P}_{E} = {K}_{L} pL} \times 3 = 0.94 t \text{/} m$$

$$T = 2 π \sqrt{\frac{{M}_{E}}{{K}_{E}}} = 2 π \sqrt{\frac{0.94}{71111}} = 0.023 s \to \frac{T}{{t}_{rf}} = \frac{0.023}{0.68 \times {10}^{- 3}} = 33.82 \to DFL = 0.142 \to {q}_{eq} = 0.142 \times 3952 = 561 kN \text{/} {m}^{2}$$

The above expressions are obtained by means of an equivalent static analysis, simulating the wall, which is treated as a doubly embedded beam, as a system of one degree of freedom.

It is observed that, without the protective barrier, the load acting on the wall is 40 times greater than for the scenario studied. It therefore follows that the proposed system is highly effective. In order to be able to support this level of load with a conventional solution, it would be necessary to have a wall of great thickness with buttresses, etc., giving rise to a very significant occupation of space.

The system is, therefore, a barrier based on damping, in which much of the energy of the explosion is transformed into the kinetic energy of an oscillating mass. From the example given above, it can be deduced that damping barriers are a very effective and promising alternative, which are also made up of elements that are easy to manufacture and install. It is of a type that enables adequate integration into architecture and can be combined with windows that allow visualization of the damping system. A clear application of this can be the protection of control rooms.

1. (canceled)

2. A system for blast load protection using a damping barrier, comprising:
a moveable first wall (1) for receiving a pressure wave, the first wall (1) being connected to a second wall (2), the second wall forming part of a structure to be protected; and
a plurality of oscillatable elastic dampers connecting the first wall (1) to the second wall (2) so that the moveable first wall is an oscillatable mass relative to the second wall; and
roller bearings supporting the first wall and facilitating movement of the first wall relative to the second wall when the pressure wave is received.

3. The system of claim 2, wherein the first wall is metallic.

4. The system of claim 2, wherein the elastic dampers are oscillators.

5. The system of claim 4, wherein the oscillators have one degree of freedom.

6. The system of claim 2, wherein the elastic dampers are springs.

7. The system of claim 6, wherein the springs are metallic.

8. The system of claim 2, wherein the roller bearings are supported on a surface (4) that facilitates movement of the roller bearings.

9. The system of claim 8, wherein the surface includes rails on which the roller bearings move.

10. A system for blast load protection using a damping barrier, comprising:
a moveable first wall (1) for receiving a pressure wave, the first wall (1) being connected to a second wall (2), the second wall forming part of a structure to be protected; and
a plurality of oscillatable elastic dampers connecting the first wall (1) to the second wall (2) so that the moveable first wall is an oscillatable mass relative to the second wall; and
rails supporting the first wall and facilitating movement of the first wall relative to the second wall when the pressure wave is received.

11. The system of claim 10, wherein the first wall is metallic.

12. The system of claim 10, wherein the elastic dampers are oscillators.

13. The system of claim 12, wherein the oscillators have one degree of freedom.

14. The system of claim 10, wherein the elastic dampers are springs.

15. The system of claim 14, wherein the springs are metallic.
